(19) United States
(12) Patent Application Publication
(10) Pub. No.: US 2010/0112124 A1
(43) Pub. Date: May 6, 2010

(54) NOVEL METHOD TO REDUCE COMPOUNDS INVOLVED IN MAILLARD REACTIONS IN THERMALLY PROCESSED PLANT-BASED FOOD PRODUCTS

(76) Inventor: Hugo Streekstra, Amsterdam (NL)

Correspondence Address: NIXON & VANDERHYE, PC, 901 NORTH GLEBE ROAD, 11TH FLOOR, ARLINGTON, VA, 22203, US

(21) Appl. No.: 12/515,791

(22) PCT Filed: Nov. 20, 2007
(86) PCT No.: PCT/EP07/62570

§ 371 Date: Nov. 11, 2009

(30) Foreign Application Priority Data
Nov. 23, 2006 (EP) 06124680.7
Dec. 5, 2006 (EP) 06125441.3

(51) Int. Cl. A23L 1/015; A23L 1/217; A23L 1/28; A23L 1/214

(52) U.S. Cl. 426/10; 426/52; 426/50; 426/637

(57) ABSTRACT

This invention relates to a novel method to prepare a thermally processed plant-based food product containing less detrimental side products of Maillard reactions comprising the step of removing at least one compound involved in Maillard reactions in thermally processed plant-based food products by treating the plant-based intermediate of the food product with an enzyme preparation comprising at least one enzyme specifically acting on only one of the polysaccharide networks responsible for the macro-structural properties of the plant-based intermediate.

### FIELD OF THE INVENTION

This invention relates to a novel method to reduce the amount of detrimental side products of Maillard reactions in thermally processed plant-based food products.

### BACKGROUND OF THE INVENTION

As is known from ‘The Maillard reaction in Foods and Medicine’ (O'Brien et al. (eds.), 2000, Walter de Gruyter, New York), the Maillard reaction will take place from a certain temperature in thermally processed food products, such as plant-based food product.

The Maillard reaction will result in a nicely browned surface and a food product having good organoleptic properties (for example flavour, aroma, crispiness). It is however also known that the Maillard reaction also can give rise to detrimental side products, such as for example: furan compounds (O'Brien et al.) and acrylamide (Mottram et al., Nature 419:448, 2002).

It is the objective of the present invention to selectively prevent formation of detrimental side products of the Maillard reaction in thermally processed plant-based food products, preferably without destroying the structural property of the food products.

### SUMMARY OF THE INVENTION

Surprisingly, has been found that it is possible to prepare a thermally processed plant-based food product comprising the step of removing at least one compound involved in Maillard reactions in thermally processed plant-based food products by treating the plant-based intermediate of the food product with an enzyme specifically acting on only one of the polysaccharide networks responsible for the macro-structural properties of the plant-based intermediate. Use of this process can result in a food product having the structural properties as desired whilst simultaneously decreasing the amount of detrimental side-products formed by the Maillard reaction. Examples of such detrimental side products are furan compounds and acrylamide.

### DETAILED DISCLOSURE OF THE INVENTION

In general, the plant cell wall cell wall comprises two interacting, but largely independent, networks of polysaccharides responsible for the macrostructural properties: the pectin network and the cellulose-hemicellulose network.

Plant cell-wall degrading enzymes are commercially available. They are used in the preparation of beverages, for instance to enhance the filtration of fruit juices, in paper and pulp processing, in the preparation of animal feeds, for textile treatment. Usually, these are mixtures of a large number of enzymes, making good use of the cooperation between the various enzyme activities to achieve a fast and extensive breakdown of the cell wall polymers, resulting in loss of structural integrity of the substrate.

Surprisingly, it has now been found that it is possible to at least partially degrade only one of these networks by enzyme treatment, and leave the other network intact, thereby keeping structural stability of the overall food product, whilst enhancing extraction of compounds involved in Maillard reactions from the food intermediate. It is the intention of the invention to decrease the amount of detrimental side products, therefore preferably the compounds involved in the formation of those detrimental side products of the Maillard reaction are extracted. Decrease of the amount of the detrimental side products is defined in this invention relative to a thermally processed plant-based food product produced with a conventional method. Preferably the level of the detrimental compound in the food product is reduced by at least 10%, preferably at least about 30%, more preferably at least about 50%, even more preferably at least about 70% and most preferably at least about 90%.

In one embodiment of the invention, the invention relates to a novel method to produce a thermally processed plant-based food product in order to decrease the amount of detrimental side-products of the Maillard reaction, comprising the steps of:
a. adding at least one enzyme to an intermediate form of said food product in an amount that is effective in partially degrading only one network responsible for the macro-structural properties of the intermediate food product;
b. extraction of at least one compound involved in Maillard reactions from said intermediate food product;
c. heating said intermediate food product to form the final food product.

Any thermally processed plant-based food product can be produced in the method according to the invention.

The food product may be made from at least one raw material that is of plant origin, for example tubers such as potato, sweet potato, or cassava; legumes, such as onions, peas or soy beans; aromatic plants, such as tobacco, coffee or cocoa; nuts; or cereals, such as wheat, rye, corn, maize, barley, groats, buckwheat, rice, or oats. Also food products made from more than one raw material are included in the scope of this invention, for example food products comprising both corn and potato.

Especially suitable food products are food products whereby the food product is processed in a way that includes at least one wet processing step, such as for example washing or blanching.

The invention is especially suitable for potato-based food products comprised of a macroscopic fraction of potato, for example peeled or cut potato such as potato slices, or potato blocks. The potato intermediate is for example suitable for production of French fries or potato chips (crisps).

In the industrial manufacturing of French fries, the potatoes are generally peeled by steam-peeling. Then the potatoes are cut into the desired form, and blanched in a water bath. There are various methods of blanching that differ in the duration and/or temperature of the treatment. During the blanching process, the potato enzymes are inactivated, and some of the soluble components are extracted—insofar the blanching water is not already saturated with the soluble component. To achieve the desired result, it is common to vary the duration and temperature of the treatment. This treatment may be short and hot (about 75-90° C.), or longer and relatively cold (about 60-75° C.—not too low to avoid microbial spoilage), and these treatments may also be combined in sequence. In all cases, the goal is to modify the potato tissue to a form that is no longer raw, but also not fully cooked. This means that the starch has gelatinized to a large extent, but that the structural integrity is still high. In particular the cellular structure is still intact (Van Loon, 2005, PhD Thesis, Wageningen Univ.) The blanched potato cuts may then undergo a number of subsequent treatments, which may or may not be combined into a single treatment step. Treatments that are commonly used are: treatment with sodium pyrophosphate (to improve surface characteristics and to chelate metals that may cause decoloration), extraction of soluble components, conditioning with glucose. These treatments are usually performed in a dipping bath where the water contains the treatment substance—if any—but in principle this may also be achieved by spraying the substance (in dissolved form) onto the cuts. Also, some form of coating may be provided to cover the cuts. In all cases, the cuts must be dried (or conditioned) to a desired moisture level prior the first frying step (par-frying). After par-frying, the cuts are usually packed, and either distributed fresh, or frozen. The second frying step (finish frying) is usually performed just prior to consumption. When enzymes of a suitable thermostability are used, the blanching step may be very suitable to perform enzyme treatment. If this is not desired, because of too low thermostability or for any other practical reasons, the conditioning steps between the blanching and the drying seem to be especially suitable for enzyme treatment. So, the enzyme may be added to a dipping or spraying solution comprising sodium pyrophoshate or other buffering agents, salts, chelating agents and/or surface treatment agents, and/or glucose and/or other sugars, amino acids. Alternatively, the enzyme may be employed in a dipping or spraying solution without additional components. Alternatively, the enzyme may be added to a coating used for covering the surface of the cuts. Most of the enzymatic conversion may take place during the dipping, but also during the subsequent drying and/or moisture conditioning steps. When the enzyme is added in a spraying solution or in a coating, the enzymatic conversion will generally take place during the drying or moisture conditioning step.

In the industrial manufacturing of potato chips (crisps), the potatoes are generally peeled by steam-peeling. Then the potatoes are cut into the desired form (slices) under water. They are then transported, dried, and fried. Additional ingredients, such as salt, spices and flavors, are usually added after frying. Clearly, compared to the French fries process, the usually practice is a faster and shorter process, but additional treatments may be introduced between the cutting and the drying step. An intermediate form of the food product is defined herein as any form of the plant-based food product that occurs during the production process. Preferably, the intermediate already has the shape and size of the food product that is subjected to the heating step(s). In another sense, it is characteristic of the intermediate form of the food product is that its surface areas are substantially the same as the surface areas of the form of the food product that is subjected to the heating step(s), although it is admissible that additional surface areas are formed after introduction of the enzyme, for instance by cutting, as long as the new surface area constitutes a relatively minor fraction of the total surface are, preferably less than 20% of the total area, more preferably less than 15% of the total area and most preferably less than 10% of the total area.

The intermediate forms of the food products can fall into the following two classes. The first class may be characterized as “blocks”. These are essentially three-dimensional structures, where all three dimensions have macroscopic sizes, for example at least 0.5 cm. Alternatively, this form may be regarded as a form in which not one of the dimensions is much smaller than the other two. This class is characterized by a relatively low surface-to-volume ratio. A practical example are French fries, cut from potato. The second class may be characterized as “slices”. These are essentially two-dimensional structures, where one of the dimensions is much smaller than the other two, and characteristically measures less than 0.5 cm, preferably less than 0.4 cm, more preferably less than 0.2 cm, most preferably at most 0.135 cm. This class is characterized by a relatively high surface-to-volume ratio. A practical example are potato chips (crisps), being slices cut from potato.

The intermediate form does not necessarily comprise all the individual raw materials and/or additives and/or processing aids. Whether, when, or where other components, such as seasonings, flavorings, or other additives, are added, is not relevant with respect to the present invention For example, for the food products french fries, the intermediate forms comprise the raw cut potato blocks, the blanched potato blocks, the potato blocks before and after any additional conditioning step—such as pyrophosphate dipping, sugar dipping, coating, drying—performed prior to the first frying step, and the potato blocks after the first industrial frying step, and the potato blocks before or after any additional step prior to the final heating step performed before consumption of the food. In another example, for the food product potato chips, the intermediate forms can be the same. In current industrial practice, potato chips are prepared from raw potato—therefore the blanching step is not performed—but if it were desired one could make a food product using blanched potato slices. The intermediate form to which the enzyme is applied does not have to be subjected to the heating step directly—additional processing steps may take place between the addition of the enzyme and the heating step.

All types of enzymes that can partially degrade one of the networks can be used, such as for example a cellulose or hemicellulase for the cellulose hemicellulase network or pectinase for the pectin network. Suitable classes of cellulytic, hemicellulytic and pectinolytic enzymes can be found in ‘Enzyme Nomenclature 1992’ (Academic Press IUBMB)

Pectinase is a general term gathering all enzymatic activities that act on pectin as substrate. Pectin is, with cellulose and hemicellulose, part of the plant cell wall. Pectins are very complex hetero-polysaccharides that can be categorized to two different regions.

The “smooth” regions (homogalacturonan) comprise a backbone of (1,4)-linked α-D-galacturonic acid (GalA) residues that can be acetylated at O-2 or O-3 or methylated at O-6. α-L-Rhamnose (α-1,2) interruption of the GalA backbone may alter the 3-D structure of the polymer by introducing kinky shapes.

The “hairy” regions are composed of two different structures: xylogalacturonan and rhamnogalacturonan. The xylogalacturonan consists of a D-xylose-substituted galacturonan backbone. The xylose residues are β-(1,3) linked to the galacturonic acid residues. Some of the galacturonic acid residues are methyl-esterified. The rhamnogalacturonan is a polymer of galacturonic acid residues, interrupted by rhamnose residues (α-1,2 linked). The ratio Rha/GalA may vary from 0.05 to 1. Long arabinosyl- and galactosyl-rich side chains are attached at O-4 of a rhamnose residue. The arabinan chain consists of a main chain of α-1,5-linked arabinose residues that can be substituted by α-1,3-linked-L-arabinose and by feruloyl residues attached terminally to O-2 of the arabinose residues. The galactanan side chains contain a main chain of β-1,4-linked D-galactose residues, which can be substituted by feruloyl residues at O-6.

The complexity and the heterogeneity of pectins is reflected in the large number of activities involved in its degradation. Two sets of enzymes can be discriminated, the homogalacturonan-degrading enzymes and the rhamnogalacturonan-degrading enzymes. Each class can be further divided into two subsets, i) backbone-degrading enzymes and ii) accessory enzymes.

The smooth region (homogalacturonan) backbone can be hydrolysed by pectin lyase, pectate lyase and polygalacturonases (exo and endo types). The pectate-hydrolysing activities, such as the pectate lyase and the endo polygalacturonases, act in synergy with pectin methyl esterase and acetyl pectin esterase.

The hairy region backbone is specifically hydrolysed by rhamnogalacturonan hydrolase and lyase, in synergy with the rhamnogalacturonan acetyl esterase. Many accessory activities are required to fully hydrolyse the different side chains linked to the backbone polymer, where arabinan and galactan side chains are the most represented.

In the context of the invention, it is most efficient to cut the backbone of a polysaccharide network. Preferably a pectin-hydrolysing enzyme is used. It is known in the field of pectin degradation that—especially in the absence of auxiliary enzymes—the backbone of the smooth region is more accessible than the backbone of the hairy region. Therefore, most preferably an endo-polygalacturonase (EC 3.2.1.15) is used.

It was surprisingly found that the use of an endo-polygalacturonase reduces the amount of compounds involved in Maillard reactions in plant-based food products, thereby diminishing the amount of detrimental compounds in the final food product, whist retaining good structural properties.

In potato tubers, for example, the pectic polysaccharides make up about 56% of the cell wall material. Characteristic polysaccharides of the cellulose-hemicellulose network are cellulose, xyloglucan (hemicellulose), and mannan. Together, these make up about 44% of the walls of potato tuber cells.

It is possible that in the enzyme preparation used several different enzymes are present.

Preferably, an enzyme preparation is used comprising an enzyme having predominantly one type of cell-wall degrading activity and that is substantially free of other types of cell-wall degrading activity. Preferably, the enzyme preparation's enzyme content having cell wall degrading activity is comprised of at least 60% of the predominant cell-wall degrading enzyme, more preferably at least 70%, even more preferably at least 80% and most preferably at least 90%. It is possible that in the enzyme preparation according to the invention auxiliary non-cell-wall degrading enzymes are used. This depends on the application, and preferably such enzymes are capable of degrading the compounds involved in Maillard reactions, such as for example sugar and amino acid oxidases or hydrolases. Examples of suitable auxiliary non-cell wall degrading enzymes are hexose oxidase, glucose oxidase, amylase, amidase, glutaminase and asparaginase or a mixture of any of these. Preferred auxiliary enzymes are hexose oxidase or asparaginase or a mixture thereof. The auxiliary enzymes can be added simultaneously or separately from the cell-wall degrading enzyme activity.

At least partially degrading of at least one of the networks present in the plant-based intermediate can be measured by measuring the amount of at least one component of the network that is solubilized. The level of degradation of the insoluble network is then quantified by the amount of material that has been transferred to the solution. In the case of complex polysaccharides, this would be the level of specific monomers that have gone into solution, or—in the case of endo-activities—the increase in the number of free polysaccharide end-groups. The monomers will often be sugar or sugar acid monomers, but it is also possible to use the alcohol groups liberated by hydrolysis of ester bonds to this purpose. To quantify the number of free polysaccharide end-groups one may use a less specific, but more generally applicable method, such as the total level of reducing ends: for every hydrolysis step of a polysaccharide the number of reducing ends increases by 1.

The maintenance of the structural integrity can be analyzed with a texture analysis on the intermediate plant-based food product. Therefore one can determine the amount of structural integrity by measuring the force required to lower a probe into the plant tissue. Alternatively, one may measure the distance that the probe sinks into the plant tissue when a constant force is applied. The shape of the probe and the force applied depend on the firmness of the tissue in question, but this does not change the principle of the measurement. Hence, we can define the raw, untreated plant tissue to have a firmness of 100%, and the fully fluidized plant matrix—where the shape of the original tissue is no longer maintained—as 0%. A substantially maintained structural integrity is herein defined as the tissue having at least 20% residual firmness, preferably at least 30%, more preferably at least 40, 50, 60, 70 or 80% and most preferably at least 90%. It should be realized that some treatments may actually increase the firmness of the tissue. Hence, a firmness greater than 100% is even possible.

At least a portion of compounds which are involved in Maillard reactions are removed from the food intermediate by extraction. Preferably the level of such compounds in the food intermediate is reduced by at least 10%, preferably at least about 30%, more preferably at least about 50%, even more preferably at least about 70% and most preferably at least about 90%. Extraction includes any means of contacting the food material with a solvent, preferably an edible solvent, such as for example water, such that at least a portion of the compounds involved in Maillard reactions are removed. Suitable extraction methods include soaking, leaching, washing, rinsing, blanching, dominant bath or combinations thereof. Since extraction also can lead to removal of other compounds than desirable, for example soluble components involved in flavor or nutritional effects, one preference is to use the dominant bath extraction process as disclosed in for example US2004/0101607, which is herein enclosed for reference, in order to only selectively extract one or more components from the food intermediate. This is especially suitable for French fries and crisps production processes, wherein generally the potato parts are processed in water baths already saturated with water soluble compounds (mostly originating from the cell cut at the surface area of the potato).

Examples of compounds which are involved in Maillard reactions are for example water-soluble components, such as for example sugars and amino acids.

Examples of such sugars are glucose, maltose and fructose. Examples of such amino acids are lysine, asparagine, glutamine, cystein, methionine, proline, serine, phenylalanine, tyrosine and/or tryptophane. In case sugars are to be removed from the plant-based food intermediate, for example an hexose oxidase can be used as an auxiliary enzyme.

In one embodiment of the invention glucose is extracted from the plant-based food intermediate. Glucose is believed to be a involved in the formation of for example acrylamide. In case of glucose removal from the plant-based food intermediate, glucose oxidase is a preferred auxiliary enzyme.

In another embodiment of the invention asparagine is extracted from the plant-based food intermediate. Asparagine is believed to be a precursor of for example acrylamide.

Also a combination of glucose and asparagine may be extracted from the plant-based food intermediate.

Recently, the occurrence of acrylamide in a number of heated food products was published (Tareke et al. Chem. Res. Toxicol. 13, 517-522 (2000)). Since acrylamide is considered as probably carcinogenic for animals and humans, this finding had resulted in world-wide concern. Further research revealed that considerable amounts of acrylamide are detectable in a variety of baked, fried and oven prepared common foods and it was demonstrated that the occurrence of acrylamide in food was the result of the baking process.

The official migration limit in the EU for acrylamide migrating into food from food contact plastics is set at 10 ppb (10 micrograms per kilogram). Although no official limit is yet set for acrylamide that forms during cooking, the fact that this values presented above abundantly exceed this value for a lot of products, especially cereals, bread products and potato or corn based products, causes concern.

A pathway for the formation of acrylamide from amino acids and reducing sugars as a result of the Maillard reaction has been proposed by Mottram et al. Nature 419:448 (2002). According to this hypothesis, acrylamide may be formed during the Maillard reaction. During baking and roasting, the Maillard reaction is mainly responsible for the color, smell and taste. A reaction associated with the Maillard is the Strecker degradation of amino acids and a pathway to acrylamide was proposed. The formation of acrylamide became detectable when the temperature exceeded 120° C., and the highest formation rate was observed at around 170° C. When asparagine and glucose were present, the highest levels of acrylamide could be observed, while glutamine and aspartic acid only resulted in trace quantities.

Several plant raw materials are known to contain substantial levels of asparagine. In potatoes asparagine is the dominant free amino acid (940 mg/kg, corresponding with 40% of the total amino-acid content) and in wheat flour asparagine is present as a level of about 167 mg/kg, corresponding with 14% of the total free amino acids pool (Belitz and Grosch in Food Chemistry—Springer New York, 1999). The fact that acrylamide is formed mainly from asparagine (combined with reducing sugars) may explain the high levels acrylamide in fried, oven-cooked or roasted plant products. Therefore, in the interest of public health, there is an urgent need for food products that have substantially lower levels of acrylamide or, preferably, are devoid of it.

A variety of solutions to decrease the acrylamide content has been proposed, either by altering processing variables, e.g. temperature or duration of the heating step, or by chemically or enzymatically preventing the formation of acrylamide or by removing formed acrylamide.

One of the main problems with acrylamide reduction, is that the structure and texture of food products treated to reduce the acrylamide formed during their processing, is not to be compromised. This is especially the case for food products comprising intact cell structures.

It is disclosed in US2005/0074538 that foods that are sliced and cooked as coherent pieces may not be readily mixed with various additives without physically destroying the cell structures that give the food products their unique characteristics upon cooking, such as for example French fries and potato chips.

Therefore, it is the objective of the present invention, to reduce the amount of asparagine in a plant-based food product intermediate to enable reduction of acrylamide in the final food product, whilst preventing the structural matrix of the potato-based food product from turning into mash, most preferably to such an extent that the structural properties can be maintained.

In US2004/0101607 a process was disclosed for reducing the level of acrylamide in a food product comprising the optional step of increasing the cellular membrane permeability of food material, for example by use of one or more enzymes (e.g. cellulose-degrading enzymes such as cellulase, hemicellulase, pectinase or mixtures thereof). However, no mention was made with respect to the cell wall nor were structural properties of the plant-based food products mentioned. In addition, no specific preference for any of the mentioned cellulose-degrading enzymes was made or a preference to (partially) degrade only one of the networks responsible for the macrostructural properties.

It was surprisingly found that in case that one of the networks present in the intermediate plant-product is at least partially degraded, extraction of asparagine is greatly enhanced, whilst maintaining desirable structural properties. In one embodiment of the present invention a novel method to prepare plant-based food products having lower levels of acrylamide is provided.

The novel method according to the invention comprises:
a. adding an enzyme preparation comprising at least one cell-wall degrading enzyme to an intermediate form of said food product in an amount that is effective in partially degrading only one network responsible for the macrostructural properties of the intermediate food product;
b. extraction of asparagine from said intermediate food product;
c. heating said intermediate food product to form the final food product.

It has surprisingly been found that the above method reduces the amount of acrylamide formed in the final food product. For example the use of endopolygalacturonase reduced the amount of asparagine in an intermediate of a thermally processed plant-based food product and the amount of acrylamide formed in the final food product.

In another embodiment of the invention, asparaginase is added additionally to the intermediate food-product before heating as an auxiliary enzyme. Preferably, the asparaginase is added to the extraction bath.

Enzymatic routes to decrease the formation of acrylamide are amongst others the use of asparaginase to decrease the amount of asparagine in the food product, since asparagine is seen as an important precursor for acrylamide.

Surprisingly, was found that the combination of a pectinolytic enzyme and asparaginase yielded synergetic results in a decrease of acrylamide formation.

In US2005/0074538 a method is disclosed of preparation of a starch-based food product having a disrupted cellular structure, disrupted mechanically, treated with asparaginase prior to dehydration of the food product. By contrast, in the present invention, the cellular structure is disrupted enzymatically and very specific, resulting in maintenance of the main structure of the food product, unlike the food products as disclosed in US2005/0074538. Furthermore, the intermediate food product of the present invention will generally not be dehydrated prior to further processing.

The invention is hereafter illustrated by the following non-limiting examples.

### EXAMPLES

### Materials for Measurement of Asparagine

### Chemicals

Purified water, purified by UHQ2 system or equivalent
Acetonitril absolute p.a. quality

### Triethylamide (TEA)

### 4 M HCl

### Acetic Acid

Sodiumacetate trihydrate
o-phataldehyde (OPA), Fluoraldehyde Reagent Solution (Pierce)

### Standard

Asparagine (ASN) standard with an officially assigned purity

### Reagents

Mobile phase A
Dissolve 37.6 g CH₃COONa.3 aq in 2 l purified water, add 1 ml of TEA and adjust the pH to 5.9 with acetic acid. Add 140 ml of acetonitril, homogenise and filtrate the solution over a 0.45 μm filter.
Mobile phase B
Mix 600 ml acetonitrile with 400 ml purified water.
0.1 M Sodium acetate buffer pH 7
Dissolve 13.6 g of sodium acetate trihydrate in 900 of purified water set to pH 7 with acetic acid and add 100 ml acetonitrile.

### 0.1 N HCl

Pipette 25 ml of 4 N HCl in 1 liter of purified water

Method to Measure Amount of Asparagine in Potato Slices

The amount of asparagine is measured in HPLC (P4000, Thermo Finnigan) after derivatization with ortho-phtalaldehyde (OPA) with a fluorescence detector (FP2020, Jasco) using the following measurement conditions:

| Column: | Gemini, Phenomenex 150 × 4.6 mm (5 um), | | |
|---|---|---|---|
| Column temperature: | 36° C. | | |
| Flow: | 1.5 ml/min | | |
| Run time: | 8 min (20 min incl prep time) | | |
| Injection volume: | 20 μl | | |
| Tray-temperature | 10° C. | | |
| Wavelength: | Exc. wavelength 340 nm and Em. | | |
| | wavelength 455 nm, gain 10. | | |
| Mobile phase: | A: Sodium acetate buffer pH 5.9/ | | |
| | acetonitrile (935:65 v/v) | | |
| | B: acetonitrile/water (6:4 v/v) | | |
| Gradient: | Time (min) | % A | % B |
| | 0.0 | 80 | 20 |
| | 5.0 | 80 | 20 |
| | 5.1 | 0 | 100 |
| | 8.0 | 0 | 100 |
| | 8.4 | 80 | 20 |

The time needed for the derivatization reaction is used as equilibration time for the gradient.

Manual standard and sample derivatization: Pipette 50 μl of OPA, 50 μl of diluted standard ASN into a injection vial, mix and wait for approximately 1 min for the reaction to take place. Pipette 900 μl of 0.1 M sodium acetate buffer mix and analyse with HPLC. Pipette 50 μl of the sample solution and OPA derivate solution, mix and wait approximately 1 min for the reaction to take place. Pipette 1000 μl of 0.1 M sodium acetate buffer mix and analyse with HPLC (note that the OPA derivate solution is not stable and should be used within two hours).

Pretreatment standard: Weight in duplicate 25-30 mg (with an accuracy of 0.01 mg) ASN standard in a 100 ml volumetric flasks. Dissolve in 80 ml 0.1N HCl, make up the volume with 0.1N HCl and homogenize. Dilute 20 times with 0.1N HCl.

Pretreatment sample and controls: Cut the potato in potato slices (approximately 1.5 mm). Treat the slices as indicated in the experiments. Weigh 15-25 g of the potato slices (approximately 1.5 mm) into a 1000 ml flask, add 500 ml 0.1 N HCl (weigh) and suspend with an Ultra turrax mixer. Centrifuge the sample for 10 min at 13000 rpm. Dilute the sample 5 or 10 times with 0.1 N HCl to a concentration of 10 mg/l.

The samples are then analysed. The results are calculated as follows:

$$Cont ( AA ) = \frac{Area ( sample ) \times 500 \times Dil}{Rf \times W}$$

Cont(AA)=content AA in g/kg
Rf=respons factor AA
Area=peakarea AA
500=volume of 0.1 N HCL added
Dil=dilution
W=weigh sample in mg

wherein

$$Rf ( AA ) = \frac{Area ( ref ) \times 100 \times Dil}{W ( ref ) \times C ( ref )}$$

Area(ref)=peakarea AA standard
Dil=dilution AA
100=volumetric flask volume
W(ref)=weigh standard AA in mg
C(ref)=content standard AA in g/g

Experiment I: Differences in Structural Effect Between Pectinase Mix and Endo-Polygalacturonase

Cubes of 1×1×1 cm were cut from the interior of potato, rinsed with water, and put into reaction tubes. Subsequently, they were incubated with 10 ml of experimental solutions.

After 4 hours of incubation at 38° C. the potato cubes were also inspected for textural changes.

The following results were achieved:

| Example | Used experimental solution | texture |
|---|---|---|
| A | 0.5 g/l Na-pyrophosphate buffer (pH = 5) | extremely |
| | 0.5 ml pectinase/hemicellulase mix | soft |
| 1 | 0.5 g/l Na-pyrophosphate buffer (pH = 5) | good |
| | 0.5 ml endo-polygalacturonase pgaC of A. niger | firmness |

From this experiment is clear that the use of a mix of pectinase/hemicellulase destroys structural properties of the potato slices.

Experiment II: Measurement of Asparagine in Potato Slices

In the second experiment the level of asparagine in the potato was measured. To avoid a dilution of the measurement by a potential inert core region, slices of potato were used, instead of cubes.

About 13 g of potato slices was incubated in experimental solutions, with a total volume of 200 ml. This large volume avoids saturation effects by high levels of extracted compounds.

After 45 minutes of incubation at 40° C., the slices were taken from the solution and rinsed with water, the excess water was removed with filter paper, and the slices were put into 0.1 M HCl solution. Subsequently they were homogenized, and after centrifugation the water fraction was analyzed for asparagine by HPLC.

The following asparagine levels were found in the potato (expressed relatively) and also the following structural properties:

| | | | asparagine |
|---|---|---|---|
| Example | Used experimental solution | texture | level |
| B | None - Raw potato | Very Firm | +++++ |
| C | 0.5 g/l Na-pyrophosphate buffer (pH = 5) | Very Firm | ++++ |
| D | 0.5 g/l Na-pyrophosphate buffer (pH = 5) | Very Firm | +++ |
| | 20 U/ml A. niger asparaginase | | |
| E | 0.5 g/l Na-pyrophosphate buffer (pH = 5) | Extremely | ++ |
| | 20 U/ml A. niger asparaginase | soft | |
| | 0.5 ml pectinase/hemicellulase mix | | |
| 2 | 0.5 g/l Na-pyrophosphate buffer (pH = 5) | Good | + |
| | 20 U/ml A. niger asparaginase | Firmness | |
| | 0.5 ml A. niger endopolygalacturonase | | |
| | pgaII | | |
| 3 | 0.5 g/l Na-pyrophosphate buffer (pH = 5) | Good | + |
| | 20 U/ml A. niger asparaginase | firmness | |
| | 0.5 ml A. niger endopolygalacturonase | | |
| | pgaB | | |

It is seen in comparative experiments B-C-D-E that addition of asparaginase increased the diffusion of asparagine from the potato matrix, but that addition of an enzyme mix does not substantially decrease the amount of asparagine in the potato. The addition of the endo-polygalacturonases in examples 2 and 3 according to the invention, improved the asparagine diffusion and led to an almost complete removal of this amino acid from the matrix. Furthermore, the structural properties of the examples 2 and 3 are retained.

1. Method to reduce the amount of detrimental side products of Maillard reactions in a thermally processed plant-based food product, the method comprising the steps of:
a. adding an enzyme preparation comprising at least one cell-wall degrading enzyme to an intermediate form of said food product in an amount that is effective in partially degrading only one network responsible for the macro-structural properties of the intermediate food product;
b. extraction at least one compound involved in Maillard reactions from said intermediate food product;
c. heating said intermediate food product to form the final food product.

2. Method according to claim 1, wherein the enzyme preparation is substantially free of another other cell-wall degrading enzyme activity.

3. Method according to claim 1, wherein the cell-wall degrading enzyme is a pectinolytic enzyme.

4. Method according to claim 1, wherein the cell-wall degrading enzyme is an endo-polygalacturonase (EC 3.2.1.15).

5. Method according to claim 1, wherein the enzyme preparation comprises an auxiliary non-cell-wall degrading enzyme.

6. Method according to claim 5, wherein the auxiliary enzyme is glucose oxidase or asparaginase or a mixture of any of them.

7. Method according to claim 1, wherein the removed compound involved in Maillard reactions is a sugar and/or an amino acid, for example glucose or asparagine.

8. Method the reduction of acrylamide in a plant-based food product comprising:
a. adding an enzyme preparation comprising at least one cell-wall degrading enzyme to an intermediate form of said food product in an amount that is effective in partially degrading only one network responsible for the macro-structural properties of the intermediate food product;
b. extraction of asparagine from said intermediate food product;
c. heating said intermediate food product to form the final food product.

9. Use of endo-polygalacturonase (EC 3.2.1.15) to reduce the amount of asparagine in an intermediate for a thermally processed plant-based food product.

10. Use of endo-polygalacturonase (EC 3.2.1.15) to reduce the amount of acrylamide formed in a thermally processed plant-based food product.

11. Method according to claim 1, whereby the intermediate food product is peeled and/or cut potato.

12. Method according to claim 1, whereby the plant-based food product is potato chips (crisps) or French fries.

13. Thermally processed plant-based food product obtained by the method according to claim 1
